(19) United States
(12) Patent Application Publication
(10) Pub. No.: US 2004/0153547 A1
(43) Pub. Date: Aug. 5, 2004

(54) Service provisioning in a communication system

(76) Inventor: Dirk Trossen, Cambridge, MA (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/418,313

(22) Filed: Apr. 18, 2003

Related U.S. Application Data
(60) Provisional application No. 60/443,842, filed on Jan. 31, 2003.

(51) Int. Cl. G06F 15/173; G06F 15/16

(52) U.S. Cl. 709/228; 709/223; 719/318

(57) ABSTRACT

The present invention relates to provision of information for assisting making of subscriptions to services provided by means of an event server in a communication system. In the method a query message is sent from a user equipment to the event server. A response is then created to the query message, said response including information about event packages that are supported by the event server. The response is transported to the user equipment where after descriptive information regarding said event packages is obtained based on the content of the response. A service is then selected at the user equipment based on said descriptive information, and a service subscription message is sent for the selected service.

### CROSS REFERENCE TO RELATED APPLICATIONS

This application claims priority of U.S. Provisional Patent Application Serial No. 60/443,842, entitled “Service Provisioning in a Communication System,” filed on Jan. 31, 2003, the contents of which are hereby incorporated by reference.

### BACKGROUND OF THE INVENTION

1. Field of the Invention

The present invention relates to service provisioning in a communication system, and in particular, to provision of information for enabling subscription to services provided by means of at least one event server.

2. Description of the Related Art

A communication system is a facility that enables communication between two or more entities such as user terminal equipment and/or networks entities and other nodes associated with the communication system. The communication may comprise, for example, communication of voice, electronic mail (email), text messages, data, multimedia and so on.

The communication may be provided via fixed line and/or wireless communication interfaces. A feature of the wireless communication systems is that they provide mobility for the users thereof. Examples of communication systems providing wireless communication include the public land mobile network (PLMN) and wireless data networks such a the Wireless Local Area Network (WLAN). Examples of the fixed line systems include the public switched telephone network (PSTN) and various fixed line data networks.

A communication system typically operates in accordance with a given standard or specification which sets out what the various elements of the system are permitted to do and how that should be achieved. For example, the standard or specification may define if the user, or more precisely, user equipment is provided with a circuit switched service or a packet switched service or both. Communication protocols and/or parameters which shall be used for the connection are also typically defined. For example, the manner how communication shall be implemented between the user equipment and the elements of the communication network is typically based on a predefined communication protocol. In other words, a specific set of “rules” on which the communication can be based on needs to be defined to enable the user equipment to communicate via the communication system.

Each communication system operates by running various different functions. The functions of various communication systems have been developed quite independently from each other. Thus it is possible that two communication systems such as two different communication networks handle a function in a different manner. For example, different and non-compatible protocols may be used for service provisioning in different communication systems.

For example, in communication environments such as those based on protocols such as the Internet Protocol (IP) or the Session Initiation Protocol (SIP) or the current third generation (3G) communication network architectures it is assumed that various servers are used for handling the provisioning of different communication services for users. In such communication systems the communication connections may not be based on a “circuit” between the communicating nodes, but the messages may rather be transported as packets that are provided with destination address information. Hence the name packet switched systems. The server entities and the user equipment may communicate with each other based on appropriate protocols providing such a connectionless operation.

From the above the Session Initiation Protocol (SIP) is an application-layer control protocol for creating, modifying and terminating sessions with one or more participants (endpoints). SIP was generally developed to allow for initiating a session between two or more endpoints in the Internet by making these endpoints aware of the session semantics. A user connected to a SIP based communication system may communicate with various entities of the communication system based on standardised SIP messages. User equipment or users that run certain applications on the user equipment are registered with the SIP backbone so that an invitation to a particular session can be correctly delivered to these endpoints. To achieve this, SIP provides a registration mechanism for devices and users, and it applies mechanisms such as location servers and registrars to route the session invitations appropriately. Examples of the possible sessions include Internet multimedia conferences, Internet telephone calls, and multimedia distribution. Those interested will find a more detailed description of the SIP from an Internet Engineering Task Force (IETF) specification by J. Rosenberg et al titled “SIP: Session Initiation Protocol”, RFC 3261, July 2002. This document is incorporated herein by reference.

A protocol defined in the Internet Engineering Task Force (IETF) specification “SIP: Specific Event Notification”, RFC 3265, July 2002 by A. Roach describes a SIP event framework for the provision of an IP-based event delivery mechanism. This document is also incorporated herein by reference.

The SIP event framework is supposed to become an important element within the SIP infrastructure. The SIP event framework can be used for enabling event-based information provisioning to any node in the Internet. Examples for information that may be provided for the users include presence information, location information, content/service availability information, information regarding any kind of access-controlled SIP events, and so on.

The term event shall be understood to refer to any event that may be present in a communication system. For example, an event may comprise a dynamic or static mark up language document (e.g. a HTML (Hypertext Mark-up Language) or XML (Extensible Mark-up Language) document), or any other entity that may change its state and may associate with a user of the communication system.

The SIP event framework is based on the concept of the so called SIP event packages and sub-packages. A SIP event package refers to an data entity that is defined for an event. A typical event package thus defines a set of state applied to a specific type of resource, such as the user presence, call state, messaging mailbox state and so on. The set of state may be, for example, statistics, access policy, subscriber lists and so on. The sub-packages in turn can be seen as being a special type of the event packages. A sub-package defines a set of state that can be applied to event packages. A sub-package may also be applied to other sub-packages. With regard to the nature of the event packages and sub-packages a reference can be made to the object oriented analogy.

The IETF standardization for extensions to the SIP event framework, and more particularly, definition of particular new event packages, require the proposal to go through the entire IETF process, starting from drafting the proposal to becoming an RFC document and thus a SIP protocol. If the SIP event framework is going to be used for a variety of events, this process may become a significant bottleneck for the deployment of the SIP event based techniques. Even if the desired new event package is standardized, the user equipment still requires confirmation that the potential SIP event server supports the particular event package.

Furthermore, even if the user knows the events, the user may not be aware of the different or ambiguous semantics thereof so that he could subscribe to the services. For example, the SIP event server may implement SIP event packages that are entirely proprietary, i.e., their event package definition has not been standardized. Another example is when the user may need to resolve ambiguous semantics for e.g. “location” events.

The Inventor has found that an improved service discovery mechanism might be advantageous. Although SIP currently provides methods for discovering certain capabilities for known endpoints (i.e., SIP OPTIONS method for querying a server as to its capabilities for a user), this does not apply to unknown endpoints, such as unknown event servers.

It would thus be advantageous if potential subscribers to SIP event servers could query in a simple manner about event packages supported by event servers. An example of a possible scenario is wherein SIP events are used for gathering sensor data or information that was derived from such sensor data. The variety of sensor data and the even larger variety of derivation from such data makes it apparent that providing such data through the conventional SIP events framework is not very attractive considering the longish process of standardizing each and every possible event package.

The problem of obtaining information regarding event packages that are supported at a specific SIP event server and the semantics of the event packages or other descriptive information has not been addressed in the SIP world. The problem of obtaining knowledge of the semantics of the event package is either solved through standardizing the event packages or agreeing on the semantics on higher application level. Finding of an appropriate SIP event servers for the desired purpose has been considered as being an application level issue. That is, it has been for the individual service applications to solve the problem of informing potential subscriber of their existence.

### SUMMARY OF THE INVENTION

Embodiments of the present invention aim to address one or several of the above problems.

According to one aspect of the present invention, there is provided a method of subscribing to services provided via an event server in a communication system, the method includes the steps of sending from a user equipment a query message to the event server, creating at the event server a response to the query message, said response including information about event packages that are supported by the event server, and transporting the response to the user equipment. The method also includes obtaining descriptive information regarding said event packages based on the content of the response, selecting at the user equipment a service based on said descriptive information, and sending a service subscription message for the selected service based on the response.

According to another aspect of the present invention there is provided a method of subscribing to services provided via an event servers in a communication system. The method includes the steps of storing at a service discovery entity of the network descriptive information regarding event packages supported by the event servers, sending from a user equipment a service query message to the service discovery entity, selecting at the service discovery entity at least one service matching the service query message, generating a response including information regarding the selected at least one service, associated event packages and the event servers supporting said associated event packages, transporting the response to the user equipment, and sending a service subscription message from the user equipment based on information obtained from the response.

According to another aspect of the present invention there is provided an event server arranged for operation in a communication system in accordance with session initiation protocol event protocol, the event server being adapted to support at least one event service and to communicate information associated with the provision of said event service, the event server comprising means for communicating an event package description to another entity connected to the communication system.

According to another aspect of the present invention there is provided a service discovery system for responding queries regarding services available in a communication system. The system includes storage for storing descriptive information regarding event packages supported by event servers, a selector for selecting at least one service based on information in a service query message and said descriptive information stored in the storage; and a processor for generating a response including information regarding the selected at least one service, associated event packages and the event servers supporting said associated event packages.

The present invention may provide advantage on the prior art in overcoming at least the following problems. A relatively simple method of querying of a potential SIP event server for the supported event packages is provided. The user may query about the semantics and other descriptive features of non-standardised and/or proprietary events. The embodiment enables the user to dynamically query the event package information and use information from the response for a subscription. Some of the embodiments use in a new manner the already existing SIP functionalities for obtaining information for use in subscribing to the services. In other embodiments a new type of service discovery functionality is provided for obtaining knowledge of the services.

The embodiments may allow proprietary event packages to be introduced that do not need standardization. Despite this the proprietary event packages still fit into architectures that are based on the SIP event framework. This is so since the SIP event framework does not need to consider the actual semantics of the packages in order to be able to route the messages. The proprietary event packages are enabled by including appropriate semantic information in the query response that can then be used by the potential subscriber for subscribing to these packages.

Furthermore, the embodiments can be integrated with the existing SIP and service discovery methods. For example, the discovery method may be used in combination with a method of registering content and service, query and notifications using SIP event packages.

The embodiments may allow realization of the discovery process entirely on the SIP level. This reduces the complexity in the end systems due to the absence of a dedicated and non-SIP-based service discovery system.

### BRIEF DESCRIPTION OF THE DRAWINGS

For better understanding of the present invention, reference will now be made to the detailed examples of the embodiments shown in the accompanying drawings in which:

FIG. 1 shows one embodiment of the present invention;

FIG. 2 shown an example of possible user equipment;

FIG. 3 is a flowchart for a direct query from an event server in accordance with the FIG. 1 embodiment;

FIG. 4 is a signalling chart for the FIG. 1 embodiment;

FIG. 5 shows another embodiment of the present invention;

FIG. 6 is a flowchart for a query to a common service discovery functionality in accordance with the embodiment of FIG. 5; and

FIG. 7 is a signalling chart for the FIG. 5 embodiment.

### DETAILED DESCRIPTION OF THE PREFERRED EMBODIMENT(S)

The following describes two dynamic query schemes wherein it is possible to query for events with non-agreed semantics and/or based on features and/or characteristics or other descriptive information about the events. The described schemes may make it easier to use SIP events in scenarios with a great number of different possibilities.

In the present invention a user may query for SIP event servers and for available event packages. Information required for subscription is then extracted from the results of the query. The desired event package can then be subscribed, if the desired event package is found to be supported, based on the extracted information.

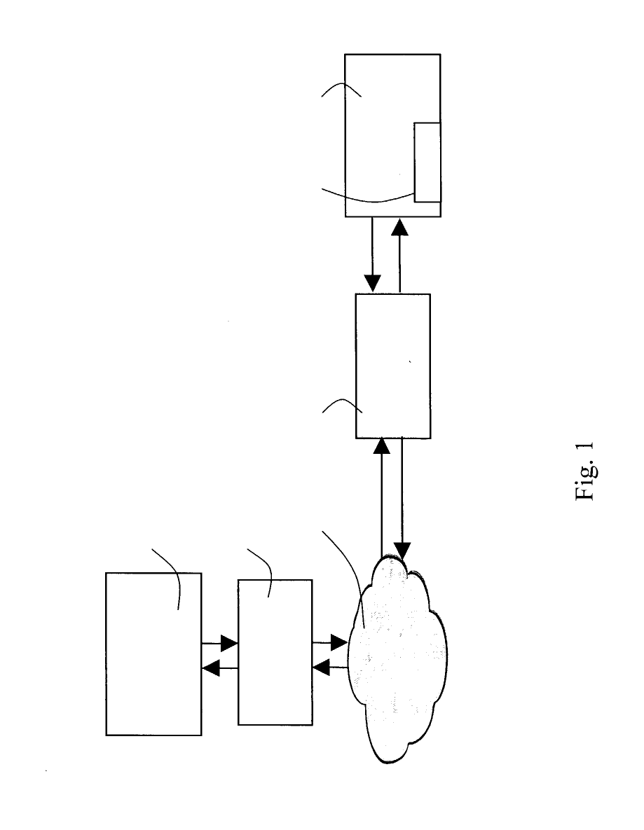

This can be processed by either directly contacting an event server or through using a special service discovery functionality. These two approaches will be described in more detail below with reference to FIGS. 1 to 7.

Reference is first made to FIG. 1 showing a possible architecture for embodying the present invention. From the shown entities the potential subscriber 1 denotes an entity which desires to subscribe to a particular SIP event. The potential subscriber may comprise any appropriate SIP compliant user equipment, such as a SIP enabled mobile station or a SIP enabled fixed line terminal (e.g. a personal computer).

The user equipment 1 wanting to subscribe to a service is provided with appropriate query and response interpretation means 2. In practice these means are provided by means of a data processor. The data processor 2 may be integrated with the other data processing means of the user equipment such as the central processing unit (CPU). The data processing function required for the present invention may also be provided as a separate processor. The implementation of the data processing function is an application level issue and depends on various factors, such as the used query language.

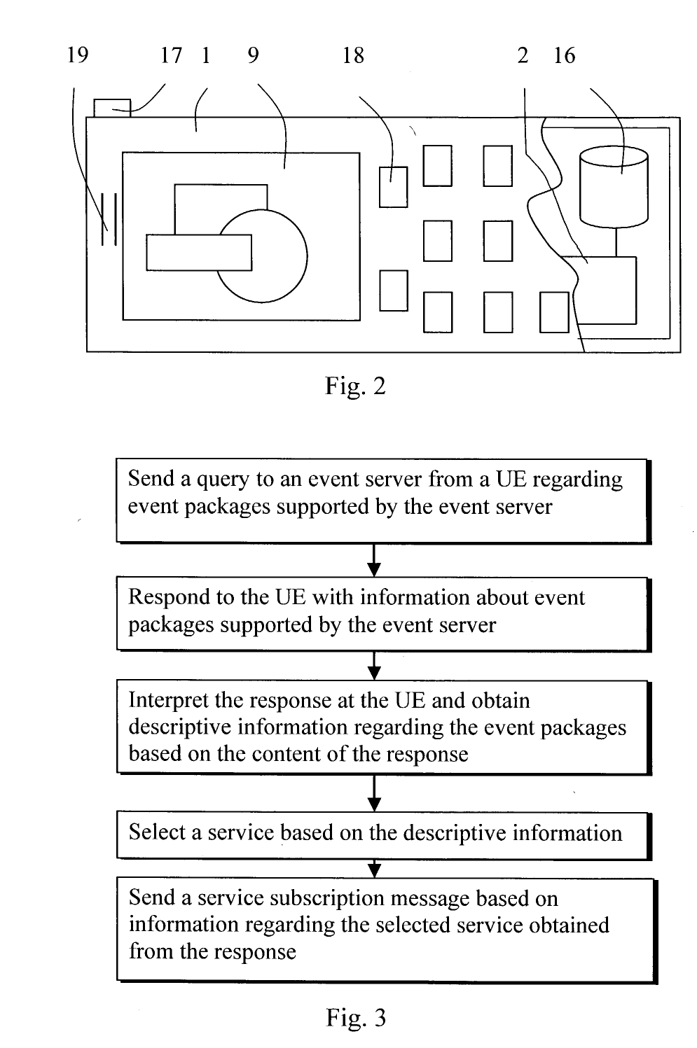

FIG. 2 is a partially sectioned image of a possible mobile user equipment 1. The exemplifying user equipment 1 is shown to comprise an antenna element 17 for wirelessly receiving and transmitting signals from and to base stations of a mobile communication network. The mobile user equipment 1 is also provided with a display 9 for displaying images and other visual information for the user of the mobile user equipment 1. Speaker means 19 are also shown. The operation of the mobile user equipment 1 may be controlled by means of control buttons 18 on the keypad thereof.

Furthermore, the mobile user equipment 1 is provided with a processor entity 2 and a memory means 16. The processor and memory means of the user equipment may be used in the embodiments of the present invention. More particularly, the processor 2 may be used for execution of various service applications at the user equipment, for processing information received for assisting in making a subscription and for processing the subscription messages generation. The memory may be used for storing data for use in the subscription process. The processor 2 may fetch data from the memory 16 via the connection between these two entities. However, it shall be appreciated that the memory and the processor may be formed as single unit, and that at least some data may be stored in the processor. This is an implementation issue, and as such does not form an feature of the present invention.

The skilled person is familiar with the features and operation of a typical mobile user equipment. Thus these do not need any further explanation. It is sufficient to note that the user may use the mobile user equipment 1 for task such as for making and receiving phone calls, for receiving content from the network and for experiencing the content presented by means of the display and/or the speaker and for interactive correspondence with another party.

The user equipment 1 may communicate with a service provider entity 6 via a communication network 3. The network 3 comprises a packet switched network that operates in accordance with the Internet Protocol (IP). The internet protocol (IP) is a so called layer 3 protocol that underlies the application layer in a layered communication system function model.

Session Initiation Protocol (SIP) messages can be delivered via the IP network. As explained above, the SIP in turn is an application-layer control protocol for creating, modifying and terminating sessions with one or more participants. A user connected to a SIP based communication system may communicate with various entities of the communication system based on standardised SIP messages.

The service provider entity 6 comprises a SIP event server. The SIP event server 6 is preferably adapted to implement SIP events in accordance with the SIP-specific event notification procedures as described in the above referenced SIP event protocol specification “SIP: Specific Event Notification” RFC 3265. The SIP event server is considered in the following as the candidate for subscription of events by the requester, i.e., user equipment 1.

Local SIP proxies 7 and 8 may also be provided. The local proxies are for interfacing the user equipment 1 and the SIP event server 6 with the IP network 3. The local proxies are responsible for handling of SIP messages. For example, the local proxies may be used to appropriately forward SIP messages to the specified entity.

It shall also be appreciated that the local SIP proxies only represent an embodiment for the forwarding of registration, subscription and notification messages in the SIP event framework. Other mechanisms could be used as well as an embodiment of the present invention. Thus, although the following describes use of the local proxies, this is done without any intention to restrict the general nature of the present invention by the use of these.

As shown by FIG. 3, the user may send a query message to the SIP event server 6. If the SIP event server 6 is contacted directly by the user equipment 1, the potential subscriber may use a SIP OPTIONS message that is addressed to the SIP event server. The SIP OPTIONS message as such is defined in paragraph 11 “Querying for capabilities” of the above referenced IETF specification No. RFC 3261 “SIP: Session Initiation Protocol”.

The SIP OPTIONS message can be sent for querying for event packages that are supported by the SIP event server. The event server 6 may then reply with the standard ‘200 OK’ message. The ‘200 OK’ message is generated such that it contains in the message body thereof the requested information.

The user equipment may have included in the query message a request regarding the format in which the information is to be provided. The event server may then generate the response accordingly.

The SIP event server 6 is preferably adapted to produce and publish a description of event packages supported by it. In the embodiment of FIG. 1 such event description may be sent directly from the event server 6 to the user equipment 1 in response to a query message from the user equipment.

Upon receipt of the ‘200 OK’ message the user equipment 1 extracts the information included in the message body from the response. If the information about the event server's supported packages contains a desired event package and its description, the information describing this event package may be used to subscribe to the particular event package with the SIP event server 6.

The event package descriptions may contain various information. The event package descriptions preferably include information at least regarding the name of the Event package and the events supported by the event server. The name information can be the actual name of the supported event package that is to be used in a following SIP event subscription. Alias or temporary names may also be used in certain occasions.

The descriptive information regarding the supported events may also define the event types that are supported in each event package. Value information may also be included in the event packet description. The value information defines for each event the possible values of the event. Parameter information can be used to define for each event or for the entire package of events which parameters are included in the event packet description.

Additional descriptive information can also be included. The additional information may describe any information beyond the above mentioned. For example, a semantic description of the event package can be included. The semantic description can be used by the potential subscriber to determine the semantics of an unknown or dynamically generated event package. The semantic description may comprise any commonly agreed symbols for description of values, ranges, attributes, and parameters of event information. It may also comprise a description such as a textual description, a list of keywords and so on. In general, semantics of a event package describe what the package is supposed to do.

The event packet description may be ordered in a hierarchical manner. That is, the various description fields such as the parameters and values may be arranged hierarchically.

The following pseudo-code outlines an example of a possible event package description representation that can be published by the SIP event server.

<package name=“location”>
<event name=“in”>
<value name=“cell”></value>
<value name=“city”></value>
</event>
<information>

“This package defines a location event package that informs about presence in a certain GSM cell or a certain city, which is derived from the cellId”

</information>
</package>
<package name=“heart beat”>
<event name=“renewal”>
<value> 30...210 </value>
<parameter name=“rate”>1...60</parameter> // rate of renewal in seconds
</event>
<information>

“This package provides heart beat information with adjustable rate of value delivery”

</information>

</package>

It shall be appreciated that the actual format in which the event package descriptions are transported is not an essential feature of the present invention. Examples of possible formats include any of the extended markup languages (XML) and format such as the resource source description (RDF).

The event packet description is received by the user equipment 1 in response to the query. The user equipment 1 of the potential subscriber may then parse the obtained description to extract the required information for its subscription to the SIP event server 6.

The parsed information is used to determine the event package or event packages that would fit the semantic needs of the application running at the user equipment. For example, in the code above, the application running at the user equipment 1 would determine that the SIP event server supports location services on two levels, that is on GSM cell and on city level. The application might then decide to use the location service to obtain location information on the city level for its purposes.

It shall be appreciated that the response from the SIP event server may contain other type of information than event package descriptions with the semantic information in each response. For example, the response may contain a link to the semantic description rather than the description itself. The link may be given, for example, as a URI (Uniform Resource Identifier). This may enable provision of a common databases for the semantics information. Such databases can be referenced to as Ontology servers. The user equipment can then use the link to the semantic description to retrieve the semantic description, for instance based on HTTP (Hypertext Transfer Protocol).

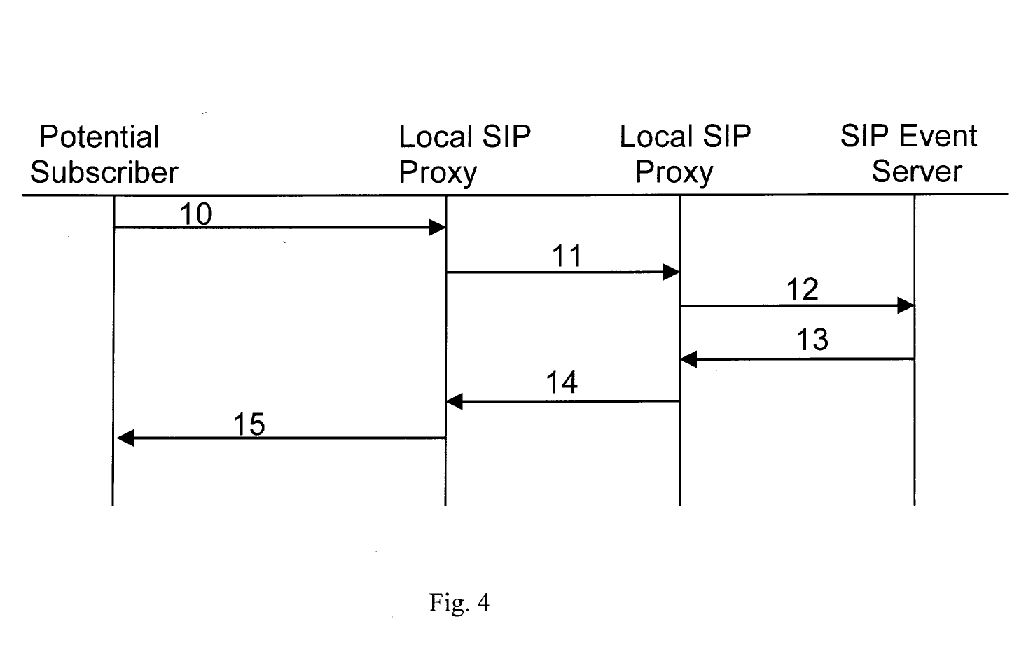

FIG. 4 is a signaling chart in accordance with the direct query scheme for the messages to be exchanged between the potential subscriber 1 and the SIP event server 6 for obtaining the event package descriptions.

The potential subscriber 1 initiates the operation by sending message 10 to the local SIP proxy 7. The message 10 is directed to the SIP event server 6. Message 10 contains, apart from the required information defined by standard procedures, a request for event package description inquiry. This can be done in the SIP OPTIONS method embodiment by appropriately setting the required fields in the message headers.

Message 10 is then appropriately forwarded as messages 11 and 12 to the SIP event server 6 via the two local SIP proxies 7 and 8 on the message path over the IP based network 3. Upon reception of message 3, the SIP event server 6 creates a description for the event packages it supports. The event package description is created to contain the information as discussed above.

The SIP event server 6 may then send back an appropriate return code. In the present SIP environment this would mean returning a ‘200 OK’ message in message 13 in FIG. 4. Message 13 is created such that it contains as a message body the generated event package description.

In the case of unsuccessful generation of the event packet description standard SIP replies may be generated and returned to inform the user of unsuccessful operation.

The message containing the event package description is then appropriately forwarded via the local proxies to the potential subscriber and arrives to the user equipment of the potential subscriber as message 15 in FIG. 4. The potential subscriber extracts, upon reception of the message, the event package description and parses it appropriately to extract the desired information.

The parsed information can then be used to subscribe to the desired event package. The subscription can be done in a per se known manner, for example by applying the SIP event framework. However, as the actual subscription does not form an essential part of the present invention, it is not described in any greater detail herein. Those interested may refer in this context to the SIP documents referenced above.

The selection of the service is preferably based on the descriptive information whereas the subscription may be made based on the event package in a per se known manner, i.e. no descriptive information is necessarily required after the event package is selected. The selection process is done based on the whole information, such as semantic description, value range of particular events, supported events, or simply on the event package. However, in certain occasions it may be necessary to specify some event package specific information in the subscription. This may be obtained from the response. For example, it may be necessary to specify a desired value for a certain event the user has selected to subscribe to. The valid value may be obtained from the content of the response message.

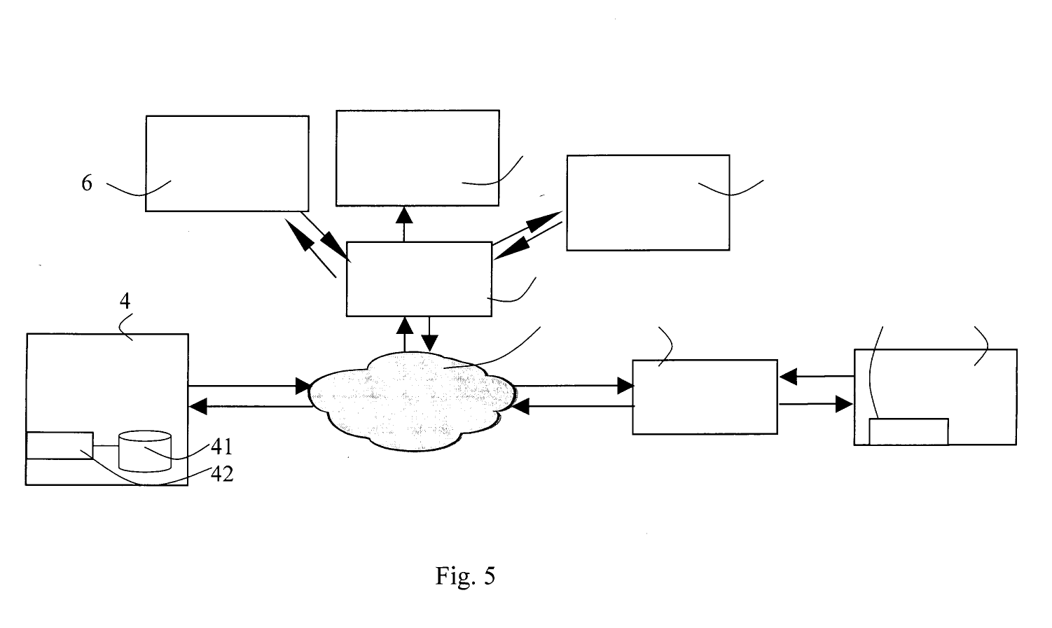

In the scheme shown in FIGS. 1, 3 and 4 it is assumed that the potential subscriber has already knowledge of the correct SIP event server and uses the method steps described above to obtain knowledge of the event packages supported by that particular event server. Rather than just discovering the event packages supported by a particular event server, the scheme shown in FIGS. 5 to 7 and described below enables the potential subscriber to discover SIP event servers that support certain event packages.

The FIG. 5 architecture is similar to that of FIG. 1 except that it further includes a service discovery system entity 4. Furthermore, a plurality of event servers 6 shown.

The service discovery entity 4 functions so as to allow for registering and querying of services. The service discovery entity 4 is shown to include a database 41 for storing information received from the plurality of event servers 6 via the interface there between over the IP data network 3. Processor means 42 are also shown. The processor means 42 are for handling the required data processing tasks, such as controlling the storage of information from the event servers and responding queries from the users.

The service discovery entity 4 together with its logical components database 41 and processor 42 represents an entire service discovery system in general. It shall be appreciated that for particular service discovery systems, such as e.g. those implemented through the Service Location Protocol (SLP), as defined in an Internet Engineering Task Force specification by E. Guttman et al. titled “Service Location Protocol Version 2”, RFC 2165, June 1999, the actual implementation and messaging within the scope of the herein proposed principles for a service discovery system has to be adapted accordingly.

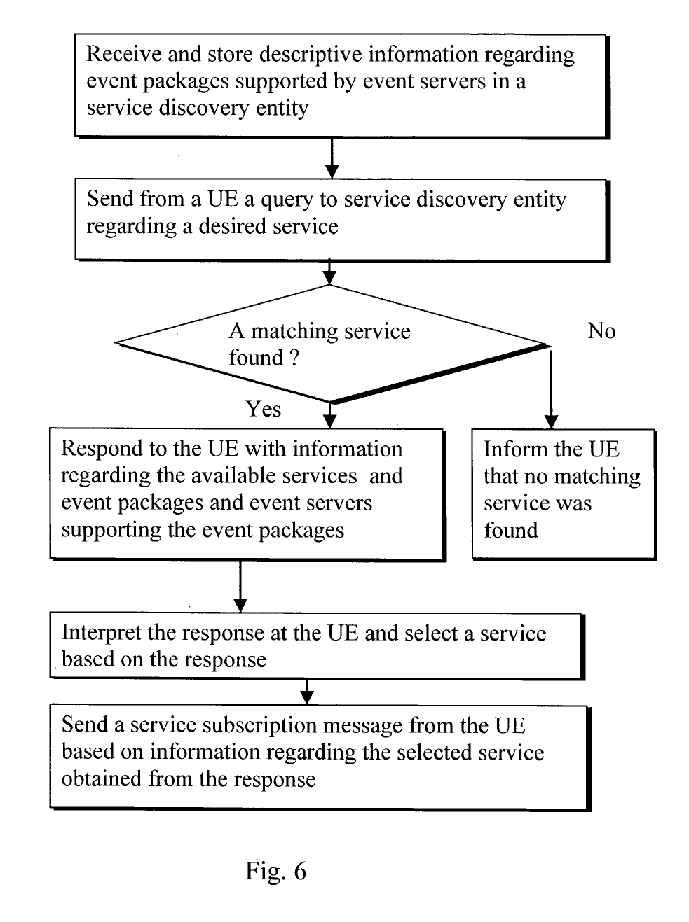

As shown in the flowchart of FIG. 6, in the service discovery scheme event package information of a plurality of SIP event servers can be registered with the service discovery system entity 4. The registration may be based on the event package descriptions discussed above. The event servers 6 may provide the entity 4 with updates of the event package description in various occasions, for example whenever a new or updated event package is introduced.

In the service discover scheme, a supported event package is treated as a service. The service is then registered through the service discovery system. Thus, the event package description serves as a service description. If necessary in the service discovery system, a service identifier is added to the description. This identifier could be “SIP Event”, although its final format and value depends either on the implementation or on standardization bodies such as the IETF. The format of the name may also depend on the ongoing standardization processes.

The query request may contain additional criteria that can be used in the selection of the appropriate event packages.

The service discovery system may respond the query with a message containing matching “SIP event” services, including the appropriate event package descriptions for each matching SIP event server and addresses of those SIP event servers.

As in the direct query scheme, the potential subscriber may then extract information from the message body of the response message from the service discovery entity 4. If the information about the event servers' supported packages contains a desired event package, the potential subscriber can use the event package information that has been provided in the response message to subscribe to the particular event package with the particular SIP event server.

The event packages can be identified based on information such as event package name, type of events and so on. The same format for the description of event packages may be used as above. However, it might be necessary to adapt the description appropriately to the used service discovery system. However, regardless of the used application the nature of the information as such remains the same.

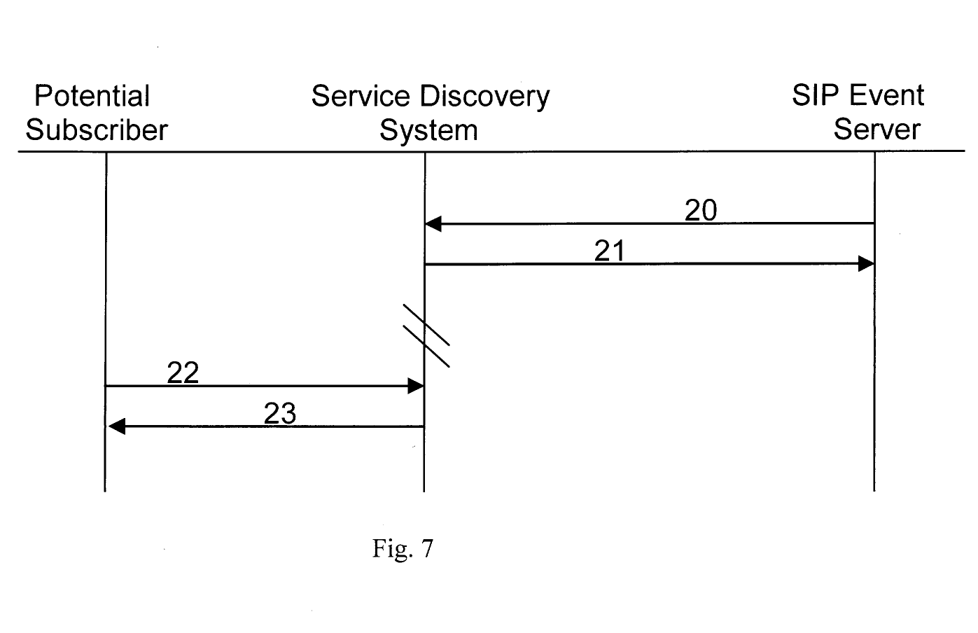

FIG. 7 shows the required signaling for this scheme. In message 20, the SIP event server 6 registers its supported event packages with the service discovery system 4. An acknowledgement may be sent by the service discovery system 4 to the event server by means of message 21.

A potential subscriber may then later query from the service discovery system 4 with message 22 for certain event packages. The query may be performed by including information regarding the desired event package as payload into message 22.

The service discovery system 4 may then respond the query message with message 23. Message 23 includes contacts points, e.g., the addresses of SIP event servers, which match the request. Additional information might be included, such as which criteria of the request message 22 matched the query. However, the possibilities for additional information will depend on the service discovery system.

The potential subscriber 1 extracts, upon reception of message 23, the event package description and parses it appropriately to extract the desired information. The parsed information can then be used to subscribe to the desired event package, applying for instance the SIP event framework.

The SIP is a possibility for the signalling between the various entities of FIG. 5. If the service discovery is implemented based on SIP events, message 20 in FIG. 7 could be e.g. SIP REGISTER or SIP PUBLISH message. These messages can be used to register the service with a SIP event-based service discovery system.

SIP already facilitates delivery of proprietary packages from the SIP event server. This is so because the present SIP protocols define a way to handle SUBSCRIBE/NOTIFY messages independently from the particular event package.

Thus message 22 in FIG. 7 from the user equipment may be a SIP SUBSCRIBE message to query for the event packages. This subscription would not only immediately return the matching event packages through message 23 in FIG. 7 but also allow for later receiving notifications of event packages that become available. These later notifications, however, are not shown in FIG. 7 for clarity. In this case, further messages similar to message 23 would be delivered upon detection of available matching event packages.

It shall be appreciated that the service discovery system can be implemented in various manners. Depending upon the service discovery system used, the messaging between the user equipment and the service discovery system has to be adapted to the particular service discovery system application. Therefore it shall be appreciated that although the messages may include information regarding SIP events, the signalling to and from the service discovery system does not necessarily involve SIP.

The herein proposed method does not just give back a list of supported events as a response to a query. Instead a semantic description of an event package or several event packages is returned. The embodiments enable the user to receive information about the semantics of the events of SIP event servers, and enables use of proprietary events.

More flexible creation of new events may also allow dynamic creation of event packages based on particular application or service semantic.

It shall also be appreciated that the exact nature and format of the messages and the therein contained information are not an essential element of the present invention. Appropriate extensions to the SIP message formats and appropriate descriptions of event packages and their semantics, such as attribute-, RDF-, or XML-based, are possible candidates for embodiments. However, the final format may need to be defined within appropriate standardization bodies such as the IETF.

It should be appreciated that whilst the above refers to mobile user equipment such as mobile stations, embodiments of the present invention are applicable to any other suitable type of user equipment such as personal computers (PC), personal data assistants (PDA) and so on.

It is also noted herein that while the above describes exemplifying embodiments of the invention, there are several variations and modifications which may be made to the disclosed solution without departing from the scope of the present invention as defined in the appended claims.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method of subscribing to services provided by means of an event server in a communication system, the method comprising:
sending from a user equipment a query message to the event server;
creating at the event server a response to the query message, said response including information about event packages that are supported by the event server;
transporting the response to the user equipment;
obtaining descriptive information regarding said event packages based on the content of the response;
selecting at the user equipment a service based on said descriptive information; and
sending a service subscription message for the selected service based on the response.

2. The method of claim 1, wherein said step of obtaining descriptive information comprises obtaining descriptive information included in the response.

3. The method of claim 1, wherein the response contains a pointer to a database, and the method further comprises a step of retrieving said descriptive information by the user equipment using the pointer from the database.

4. The method of claim 1, wherein the step of obtaining descriptive information comprises obtaining descriptive information included in a description of event packages.

5. The method of claim 1, further comprising providing the event packages in accordance with a session initiation protocol event protocol.

6. The method of claim 1, wherein the query message comprises an OPTIONS message in accordance with a session initiation protocol.

7. The method of claim 1, wherein the response comprises an ‘200 OK’ message in accordance with a session initiation protocol.

8. The method of claim 1, wherein the step of obtaining descriptive information comprises obtaining descriptive information about the semantics of the event packages.

9. The method of claim 1, further comprising determining, based on the obtained descriptive information, whether any of the service packages meets requirements of a service application running at the user equipment, and wherein the selecting step is performed based on the results of said determining step.

10. A method of subscribing to services provided by means of event servers in a communication system, the method comprising:
storing, at a service discovery entity of the communication system, descriptive information regarding event packages supported by the event servers;
sending, from a user equipment, a service query message to the service discovery entity;
selecting, at the service discovery entity, at least one service matching the service query message;
generating a response including information regarding the selected at least one service, associated event packages and the event servers supporting said associated event packages;
transporting the response to the user equipment;
sending a service subscription message from the user equipment based on information obtained from the response.

11. The method of claim 10, wherein said step of generating the response comprises generating the response including descriptive information regarding the selected event packages.

12. The method of claim 10, wherein said step of generating the response comprises generating the response including contact points for the event servers supporting the selected services.

13. The method of claim 10, wherein the step of storing comprises storing the descriptive information including a description of event packages.

14. The method of claim 10, further comprises providing the event packages are provided in accordance with a session initiation protocol event protocol.

15. The method of claim 10, wherein the query message comprises a SUBSCRIBE message in accordance with a session initiation protocol.

16. The method of claim 10, wherein the response comprises a ‘NOTIFY’ message in accordance with a session initiation protocol.

17. The method of claim 10, further comprising sending of descriptive information regarding event packages supported by an event server from the event server by means of a ‘REGISTER’ message in accordance with the session initiation protocol.

18. The method of claim 10, further comprising sending of descriptive information regarding event packages supported by an event server from the event server by means of a ‘PUBLISH’ message in accordance with the session initiation protocol.

19. The method of claim 10, wherein the step of storing comprises storing the descriptive information about the semantics of the event packages.

20. The method of claim 10, further comprising determining, based on the stored descriptive information, whether any of the service packages meets requirements of a service application running at the user equipment, and selecting at least one service based on the results of said determining step.

21. An event server arranged for operation in a communication system in accordance with a session initiation protocol event protocol, the event server being adapted to support at least one event service and to communicate information associated with a provision of said at least one event service, the event server comprising means for communicating an event package description to another entity connected to the communication system.

22. A service discovery system for responding to queries regarding services available in a communication system, comprising:
a storage medium for storing descriptive information regarding event packages supported by event servers;
a selector for selecting at least one service based on information in a service query message and said descriptive information stored in the storage medium; and
a processor for generating a response including information regarding the selected at least one service, associated event packages and the event servers supporting said associated event packages.

23. A service discovery system for subscribing to services provided by means of an event server in a communication system, comprising:
first sending means for sending from a user equipment a query message to the event server;
creating means for creating at the event server a response to the query message, said response including information about event packages that are supported by the event server;
transporting means for transporting the response to the user equipment;
obtaining means for obtaining descriptive information regarding said event packages based on the content of the response;
selecting means for selecting at the user equipment a service based on said descriptive information; and
sending means for sending a service subscription message for the selected service based on the response.

24. The system of claim 23, wherein said obtaining means comprises means for obtaining descriptive information included in the response.

25. The system of claim 23, wherein the response contains a pointer to a database, and the system further comprises means for retrieving said descriptive information by the user equipment using the pointer from the database.

26. The system of claim 23, wherein said obtaining means comprises means for obtaining descriptive information included in a description of event packages.

27. The system of claim 23, further comprising means for providing the event packages in accordance with a session initiation protocol event protocol.
